(19) United States
(12) Patent Application Publication
(10) Pub. No.: US 2026/0297972 A1
(43) Pub. Date: Oct. 1, 2026

(54) FOLDABLE SUPPORTING DEVICE FOR THE STABILIZATION OF A BEACH UMBRELLA ON THE GROUND

(71) Applicant: SABE PRODUCTS S.R.L., Genova (IT)

(72) Inventor: Maicol SABEDDU, Genova (IT)

(73) Assignee: SABE PRODUCTS S.R.L., Genova (IT)

(21) Appl. No.: 19/489,852

(22) PCT Filed: Jun. 3, 2024
(86) PCT No.: PCT/IB2024/055412

§ 371 Date: Dec. 3, 2025

(30) Foreign Application Priority Data
Jun. 5, 2023 (IT) 102023000011310

(51) Int. Cl. E04H 12/22; A45B 23/00; A47B 37/04; F16M 11/22

(52) U.S. Cl. CPC E04H 12/2238; A45B 23/00; A47B 37/04; E04H 12/2269; F16M 11/22; A45B 2023/0012; A45B 2200/1063; F16M 2200/08

(57) ABSTRACT

A device is for stabilization of a beach umbrella on any type of ground. The beach umbrella includes a shade cloth and a pole for the supporting of the shade cloth, and a support for the beach umbrella onto the ground. The device includes a first fixing structure of the device on the beach umbrella, a cover associated with the support, and a second fixing structure for fixing of the cover to the support.

### DESCRIPTION

The present invention refers to a foldable supporting device for the stabilization of a beach umbrella on the ground and, more precisely, to foldable supporting device for the stabilization of a beach umbrella on any type of terrain such as sand, earth, rocks.

### STATE OF THE ART

As is known, in order to provide stability for beach umbrellas, a number of different solutions are available on the market.

A first solution involves the use of bags to be filled with sand and fixed to the beach umbrella to prevent the latter from flying away, however this solution does not prevent the beach umbrella from falling.

A second solution involves the use of pegs to be mounted at the tip of the beach umbrella, and which are screwed or inserted directly into the ground, however this solution cannot be used if there are stones or pebbles on the ground.

A third solution involves the use of a base to be filled with water or, alternatively, a base made of heavy material such as concrete similar. However, this type of base stabilizes the beach umbrella but is difficult to transport as it is bulky and heavy.

The present invention aims to solve the above-highlighted drawbacks of the state of the art by providing a device for the stabilization of a beach umbrella on any type of terrain such as sand, earth, rock.

The aim of the present invention is also to provide a device for the stabilization of a beach umbrella on any type of terrain which is easily transportable and efficient and safe to use for the user.

### BRIEF DESCRIPTION OF THE INVENTION

The present invention provides a foldable supporting device for the stabilization of a beach umbrella on any type of terrain, which includes ground support means, first fixing means for the fixing of said device to said beach umbrella, covering means associated with said ground support means, and second fixing means for the fixing of said covering means to said support means.

Therefore, the present invention provides a foldable supporting device for the stabilization of a beach umbrella on any type of terrain substantially according to the appended claims.

### DETAILED DESCRIPTION OF THE INVENTION

A detailed description of two preferred embodiments of the foldable supporting device for the stabilization of a beach umbrella on any type of terrain of the present invention will be now given as a no limiting example, and making reference to the attached drawings, wherein:

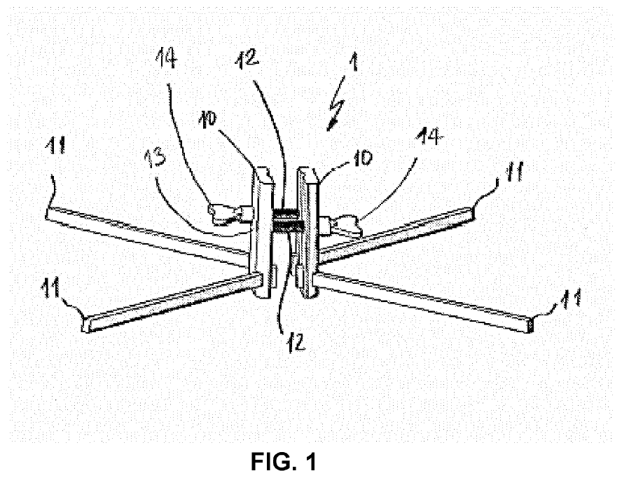

FIG. 1 is a front perspective view from above of a first component of the device for the stabilization of a beach umbrella according to a first embodiment of the present invention;

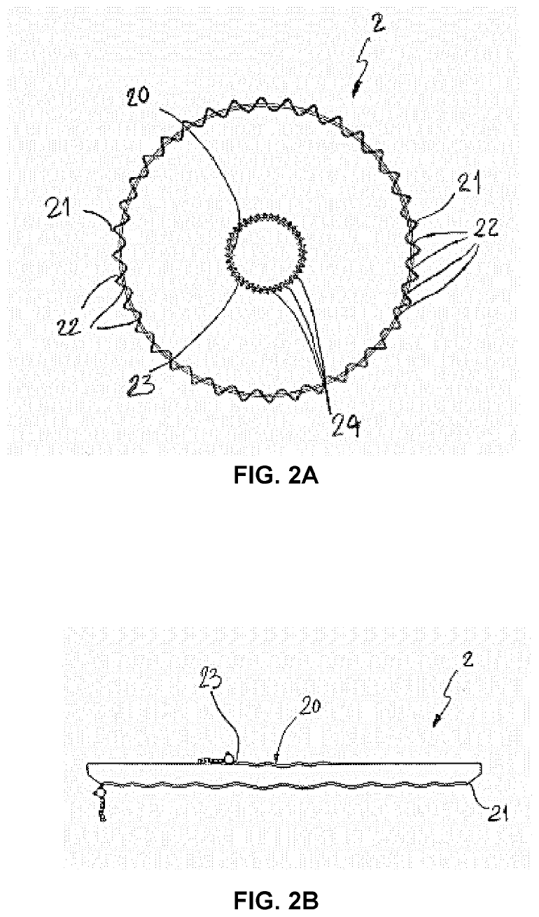

FIG. 2A is a top plan view of a second component of the device for the stabilization of a beach umbrella according to the first embodiment of the present invention;

FIG. 2B is a side elevation view of the second component of FIG. 2A of the device for the stabilization of a beach umbrella according to the present invention;

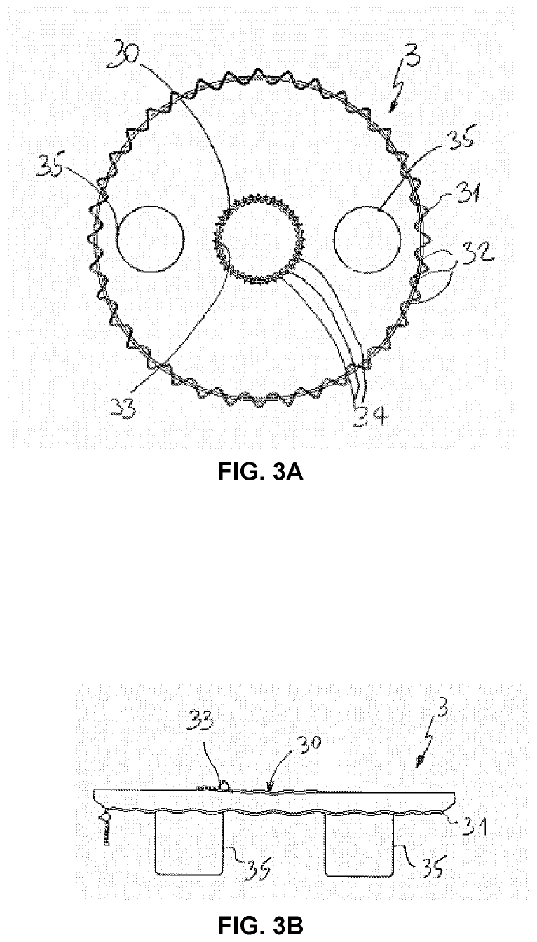

FIG. 3A is a top plan view of a third component of the device for the stabilization f a beach umbrella according to the present invention;

FIG. 3B is a side elevation view of the third component of FIG. 3A of the device for the stabilization of a beach umbrella according to the present invention;

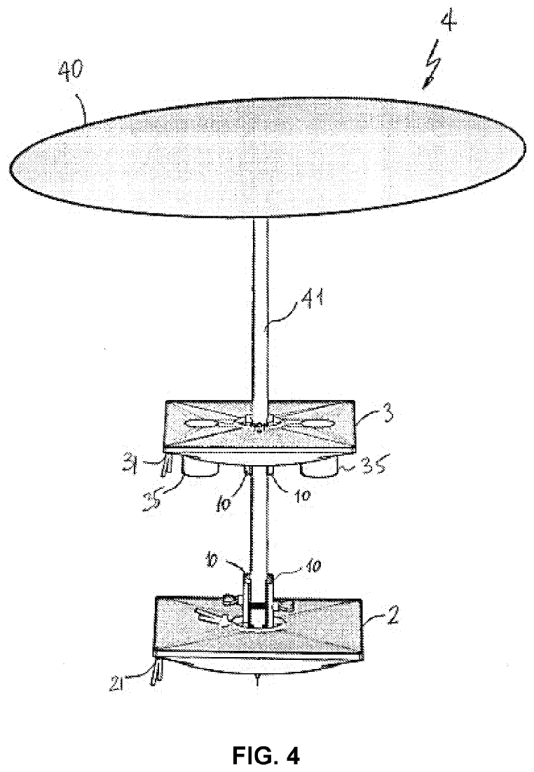

FIG. 4 is a front perspective view from above of a beach umbrella showing all the components of the device for the stabilization of a beach umbrella according to the present invention;

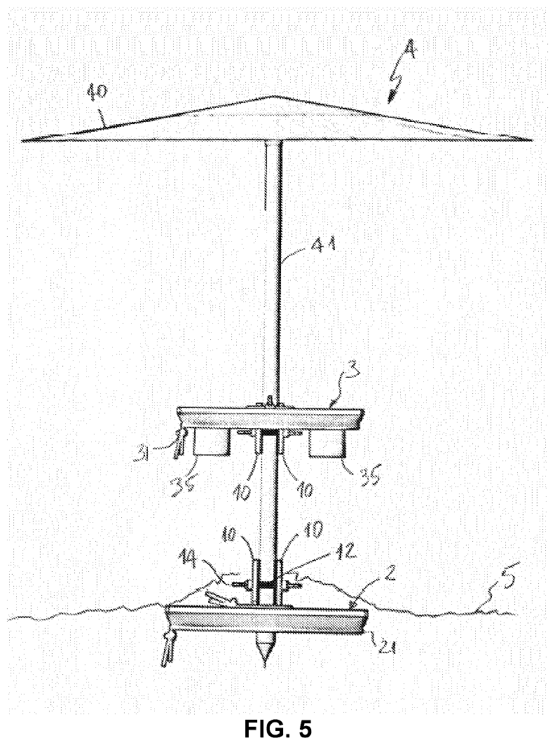

FIG. 5 is a elevation perspective view from one side of the beach umbrella of FIG. 4 which shows all the components of the device for the stabilization of a beach umbrella according to the present invention;

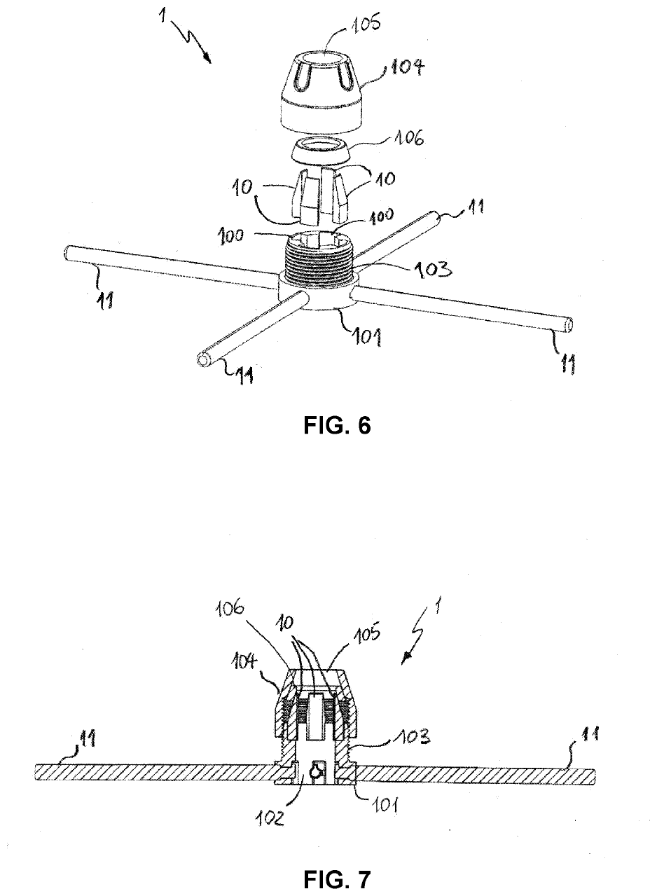

FIG. 6 is a front perspective view from above of a second embodiment of the first component of the device for the stabilization of a beach umbrella of the present invention;

FIG. 7 is a front elevation and longitudinal sectional view of the second embodiment of the first component of FIG. 6 and according to the device for the stabilization of a beach umbrella of the present invention;

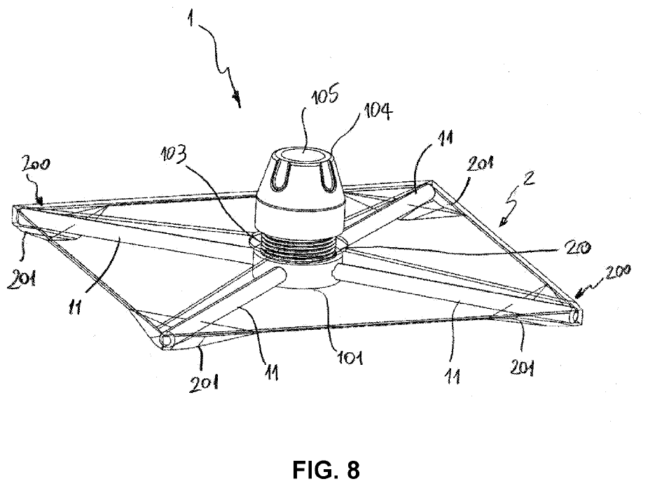

FIG. 8 is a partially transparent front perspective view from above of the second embodiment of the first component of FIG. 6 in its operating condition and according to the present invention;

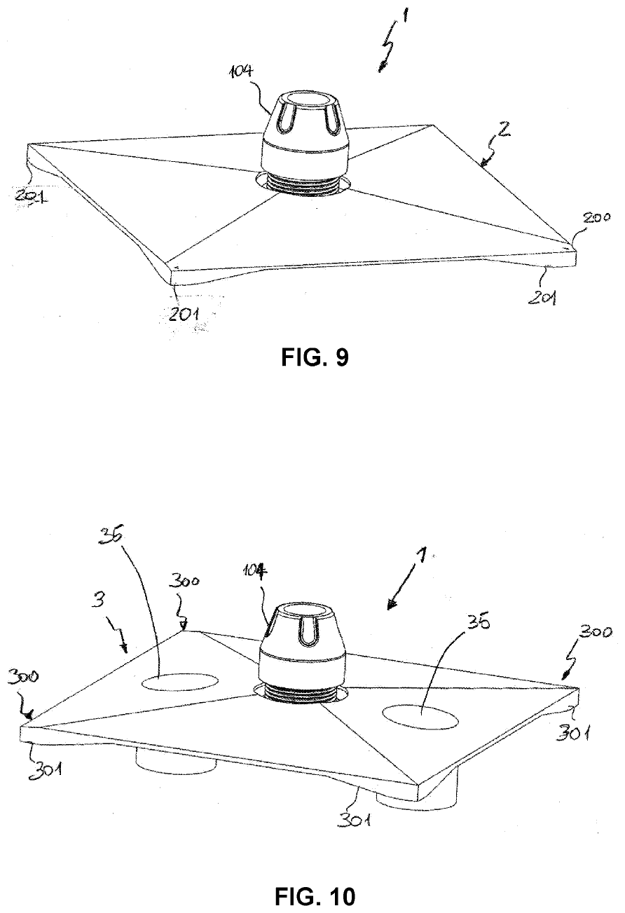

FIG. 9 is a front perspective view from above of the first component of FIG. 6 in its first operating condition and according to the present invention; and

FIG. 10 is a front perspective view from above and front of the first component of FIG. 6 in its second operating condition and according to the present invention;

Referring now to FIG. 1, it is illustrated therein a first component of device for the stabilization of a beach umbrella according to a first embodiment of the present invention. The illustrated component represents a structure that constitutes the rigid part of a base to be associated with the beach umbrella pole (better illustrated below).

The component includes a structure 1 which is made up of two jaws 10 frontally arranged one respect to the other, and each of which comprises a pair of beams 11 radially arranged onto each jaw 10. The beams 11 are made integral with the respective jaw 10 by interlocking or welding or equivalent arrangement. Further, the beams 11 can be mounted on the respective jaw 10 in a removable manner, and in such a way as to make the entire structure 1 removable to facilitate the transporting thereof by the user.

Each jaw 10 has a threaded pin 12 which has a free end that protrudes from the jaw 10, the pin 12 being arranged for being inserted and screwed into a respective threaded hole 13 at a second related jaw 10 when facing the other jaw 10.

A key 14 is connected to the other end of each pin 12 to allow the user to screw/unscrew the pin 12 into the respective threaded hole 13.

With reference now to FIGS. 2A and 2B, a second component of the device for the stabilization of a beach umbrella of the present invention is illustrated therein.

The second component is a first cloth sheet 2 or the like (i.e., fabric or similar) and which has a substantially circular shape when extended and which has a central hole 20.

At the external peripheral edge of the first cloth sheet 2 there is mounted a cord member 21 passing through a series of eyelets 22 arranged at the external peripheral edge of the cloth sheet 2, the arrangement being such that the cord member 21 completely circumscribes the external edge of the first cloth sheet 2.

Similarly, at the internal peripheral edge of the hole 20 of the first cloth sheet 2, a second cord member 23 is mounted passing through a series of eyelets 24 arranged on the peripheral edge of the hole 20, the arrangement being such that the second cord member 23 completely surrounds the internal edge of hole 20.

As will be better understood below, the function of the first cloth sheet 2 is to be placed over the structure 1 by passing the jaws 10 through the central hole 20 and enclosing the beams 11 inside the external peripheral edge of the first cloth sheet 2 by sliding the cord member 21 in the known manner (FIG. 2B).

Referring now to FIGS. 3A and 3B, a third component of the device for the stabilization of a beach umbrella of the present invention is illustrated therein. For the sake of clarity, like parts will have like numbers and detailed description thereof will be omitted here since already provided.

The third component consists of a second cloth sheet 3 which has a substantially circular shape when extended and which has a central hole 30.

At the external peripheral edge of the second cloth sheet 3, a first cord member 31 is mounted, passing through a series of eyelets 32 arranged on the external peripheral edge of the second cloth sheet 3, the arrangement being such that the cord member 31 completely circumscribes the external edge of the second cloth sheet 3.

Similarly, at the internal peripheral edge of the hole 30 of the second cloth sheet 3, a second cord member 33 is mounted passing through a series of eyelets 34 arranged on the internal peripheral edge of the hole 30, the arrangement being such that the second cord member 33 completely surrounds the internal edge of the hole 30.

Furthermore, at the central region of the second cloth sheet 3 two cylindrical pockets 35 are arranged therein, the pockets 35 protruding from one side of the cloth sheet 3.

As will be better understood below, the function of the second cloth sheet 3 is to be placed on top of a structure 1 as previously illustrated by passing the jaws 10 through the central hole 30 and enclosing the beams 11 inside the external peripheral edge by sliding the first cord member 31 in the known manner (FIG. 3B).

With reference now to FIGS. 4 and 5, a beach umbrella 4 is illustrated therein, the beach umbrella 4 comprising all the components of the device for the stabilization according to the present invention.

More precisely, the beach umbrella 4 includes a shade cloth 40 and a pole 41 in the known manner.

According to the invention, there is a first structure 1 mounted on the pole 41 at the base region of the beach umbrella 4, and a second structure 1 mounted at the median region of the pole 41.

For the mounting, first the second structure 1 is mounted and fixed at the central region of the pole 41. More precisely, first the second cloth sheet 3 is inserted on the beams 11 and passing the jaws 10 through the hole 30. Once the second cloth sheet 3 has been arranged in the illustrated manner, the latter can be blocked on the beams 11 by tightening the first cord member 31 in the manner previously illustrated.

Then, the second structure 1 thus assembled is inserted through the pole 41 between the two jaws 10 and fixed in position by tightening the pins 12 using the respective keys 14.

Subsequently, the first structure 1 is assembled by placing the first cloth sheet 2 and passing the jaws 10 at the central hole 20 and on the beams 11, locking the sheet 2 on the beams 11 and tightening the first cord member 21 in the manner previously illustrated.

Then, both the first structure 1 and the second assembled structure 1 are fixed on the pole 41 by placing the latter between the two jaws 10 and fixing the latter in position by tightening the pins 12 using the respective keys 14. In this condition, the pole 41 is positioned between the two pins 12.

It will be clear in the figure that the first base structure 1 which mounts the first cloth sheet 2 constitutes a stabilization base for the beach umbrella 4 suitable for being placed on a ground 5 and being covered therein (FIG. 5), while the second structure 1 which mounts the second cloth sheet 3 constitutes a supporting surface for accessories or drinks for the user (not shown in the figures), the drinks and/or accessories being able to be housed inside the pockets 35.

It will appear evident to those skilled in the art that through the application of the device 1 on a beach umbrella 4 a supporting base is obtained, and once positioned at the lower part of the beach umbrella 4 and resting on the surface of the ground, it can conveniently be covered with sand, rocks, or anything heavy available. In addition to the stabilizing of the beach umbrella 4, it will also act as ballast to counteract the effect of the wind.

Further, in case of using the second structure 1 as a table, a simply adjusting of the height from the ground as desired and by applying the second cloth sheet 3 to the structure 1 will be required.

Furthermore, the beams 11 of the second structure 1 can also be used to hang small objects, for example a mask and snorkel.

Referring now to FIGS. 6 and 7, a second embodiment of the first component of the device for the stabilization of the beach umbrella according to the present invention is illustrated therein.

For the sake of clarity, like items will have like numbers and the detailed description thereof will be here omitted since been already provided.

The component includes a structure 1 which is made up of four jaws 10 housed in respective regions 100 obtained on a base member 101. The base member is made up of a cylindrical body which comprises a through hole 102 suitable for the housing of the pole 41 when the latter is inserted into the base member 101.

Further, the base member 101 has four removable coupling regions for the respective beams 11, the coupling of the beams 11 on the base member 101 is obtained through insertion of the former into respective coupling regions via a removable locking as a bayonet coupling.

On the other hand, the external surface of the base member 101 comprises a threaded region 103 arranged for a threaded engagement with a respective conical-shaped locking member 104, the latter also comprising a central passing through hole 105 for allowing the insertion of the pole 41 of the beach umbrella 4 (the latter not in the figure).

Further, between the locking member 104 and the base member 101 a conical bush 106 is provided for the internal interfacing with the jaws 10 and the locking member 104. The arrangement of the conical bush 106 is such that during the screwing the locking member 104 onto the base body 101, the bushing 106 moves downwards and pushes the jaws 10 towards the central region of the base member 101. It will be evident that the arrangement is such that, once the pole 41 of the beach umbrella 4 has been inserted through the locking member 104 into the base member 101, a rotation of the locking member 104 onto the base member 101 causes the narrowing of the jaws 10 closer to the pole 41 and the locking of the latter inside the base member 101.

The unlocking of the pole 41 from the base member 101 is achieved by turning the locking member 104 in the opposite direction.

Referring now to FIG. 8, a second embodiment of the second component of the device for the stabilization of a beach umbrella according to the present invention is illustrated therein.

For the sake of clarity, like items will have like numbers and the detailed description thereof will be here omitted since already provided.

The second component is a first cloth sheet 2 which has a substantially rectangular shape when extended and which has a central hole 20 suitable for receiving the base member 101.

As can be seen in the figure, at the peripheral edge of the first cloth sheet 2 and at the four angular regions 200 thereof respective four pockets 201 are provided, each of which being suitable for the containing of a respective end part of a related beam 11. In this arrangement the first cloth sheet 2 is maintained on the rigid structure 1 formed by the beams 11 and the base member 101.

With reference now to FIG. 9, the structure 1 according to the second embodiment of the first cloth sheet 2 is illustrated therein.

In this second embodiment, the structure 1 has a rectangular shape and the first cloth sheet 2 is fixed on the structure 1 as previously illustrated, i.e. by inserting the ends of the beams 11 into the pockets 201 at the corner regions 200 (the beams 11 not being visible in the figure).

With reference now to FIG. 10, the structure 1 is illustrated therein according to the second embodiment of the second cloth sheet 3. In this second embodiment, the structure 1 has a rectangular shape and the second cloth sheet 3 is fixed on the structure 1 as previously illustrated, i.e. by inserting the ends of the beams 11 into the pockets 301 at the corner regions 300 (the beams 11 not being visible in the figure).

Further, the second embodiment of the second cloth sheet 3 includes two cylindrical pockets 35 which protrude from the bottom of the cloth sheet 3.

It will appear evident in FIGS. 9 and 10 that the second embodiment of the base structure 1 which mounts the first rectangular-shaped cloth sheet 2 constitutes a stabilization base for the beach umbrella 4 suitable for being placed on ground 5 and being covered therein (FIG. 5), while the second embodiment of the second structure 1 which mounts the second cloth sheet 3 constitutes a supporting surface for accessories or drinks for the user (not shown in the figures), the drinks and/or accessories being able to be housed inside of pockets 35.

### ADVANTAGES

The present invention has a number of advantages.

A first advantage is given by the easier and faster assembling of the beach umbrella, even for elderly people or those with little strength.

A second advantage lies in that the beach umbrella can be safely positioned and stabilised on the ground even if under the first layer of sand there are stones preventing the insertion of the pole of the beach umbrella.

A third advantage is given by the significantly increased stability that the device gives to the beach umbrella to counteract gusts of wind.

A fourth advantage lies in the fact that the structure 1 can be used to make both a supporting base and a supporting surface that can be applied to the beach umbrella.

A fifth advantage lies in the fact that a transportable reliable, safe, lightweight and compact device is obtained with the device of the present invention.

1-14. (canceled)

15. A device for stabilizing a beach umbrella on a ground, said beach umbrella comprising a shade cloth and a pole supporting said shade cloth, said device comprising:
supporting elements configured to secure said beach umbrella into said ground;
a first attachment structure configured to attach said device to said pole of said beach umbrella;
a cover assembly associable with said supporting elements; and
a second attachment structure configured to attach said covering assembly to said supporting elements.

16. The device for stabilizing a beach umbrella on a ground according to claim 15, wherein said first attachment structure and said supporting elements comprise:
a pair of jaws configured to be disposed opposite each other;
two pairs of beams associated with a respective jaw, wherein each pair of beams is configured to be mounted on the respective jaw in a radial arrangement;
two threaded pins configured to be rotatably mounted on a respective jaw, each threaded pin having a first free end configured to protrude from the respective jaw when mounted thereon;
a key configured to be mounted on an opposite end of each threaded pin; and
two threaded openings, each of the threaded openings being located in a respective jaw and being complementary to a threaded pin;
wherein, in use, to attach said device to said pole of said beach umbrella, said pair of jaws are configured to be arranged in a frontal arrangement around said pole of said beach umbrella with said pole interposed between said pair of jaws, and said threaded pin of a first jaw is configured to be inserted and screwed into the respective threaded opening of a second jaw by turning said key to tighten said threaded pins in the respective threaded openings.

17. The device for stabilizing a beach umbrella on a ground according to claim 15, wherein said covering assembly comprises:
a first fabric sheet having a central opening; and
a first cord slidably mounted along an outer peripheral edge of said fabric sheet and passing through a series of eyelets formed along said outer peripheral edge of said first fabric sheet, wherein said first cord member completely encircles said outer edge of said first fabric sheet.

18. The device for stabilizing a beach umbrella on a ground according to claim 17, wherein said covering assembly further comprises a second cord slidably mounted along an inner peripheral edge defining said central opening of said first fabric sheet, said second cord slidably passing through a series of eyelets formed along said inner peripheral edge of said central opening, wherein said second cord completely encircles said inner peripheral edge of said central opening.

19. The device for stabilizing a beach umbrella on a ground according to claim 17, wherein said first fabric sheet is configured to be being arranged over said beams with said jaws passing through said central opening and to enclose said beams within said outer peripheral edge of said first fabric sheet by tightening said first cord through said series of eyelets.

20. The device for stabilizing a beach umbrella on a ground according to claim 17, wherein said covering assembly further comprises:
a second fabric sheet having a central opening; and
a third cord slidably mounted along an outer peripheral edge of said second fabric sheet and passing through a series of eyelets formed along said outer peripheral edge of said second fabric sheet, wherein said third cord member completely encircles the outer edge of said second fabric sheet; and
a pair of cylindrical pockets located in a central region of said second fabric sheet and projecting from one side of said second fabric sheet.

21. The device for stabilizing a beach umbrella on a ground according to claim 20, wherein a fourth cord is slidably mounted along an inner peripheral edge defining said central hole of said second fabric sheet, said fourth cord passing through a series of eyelets formed along said inner peripheral edge of said central opening of said second fabric sheet, wherein said fourth cord completely encircles the inner peripheral edge of said central opening.

22. The device for stabilizing a beach umbrella on a ground according to claim 21, wherein said second fabric sheet is configured to be placed over said beams with said jaws passing through said central opening of said second fabric sheet and to enclose said beams within said outer peripheral edge of said second fabric sheet by tightening said fourth cord through said series of eyelets.

23. The device for stabilizing a beach umbrella on a ground according to claim 15, wherein said first attachment structure and said supporting elements comprise:
four jaws housed in respective regions of a base member, said base member being a cylindrical body comprising an opening for receiving said pole of said beach umbrella;
four beams configured to be removably mounted in corresponding coupling regions of said base member;
a threaded region formed on an outer surface of said base member and configured for threaded engagement with a conical-shaped locking member having a central opening for receiving said pole of said beach umbrella;
a conical bush located between the locking member and the base member, said conical bush being configured to interface with said four jaws and said locking member, wherein when said locking member is screwed onto said base member, said bush moves downwards and urges said jaws towards a central region of said base member, and wherein when said pole is inserted through said locking member and said base member, the pole is releasably clamped within the base member.

24. The device for stabilizing a beach umbrella on a ground according to claim 23, further comprising a first fabric sheet having a substantially rectangular shape, said first fabric sheet being removably attachable to said beams and comprising a central opening for accommodating said base member.

25. The device for stabilizing a beach umbrella on a ground according to claim 24, wherein said first fabric sheet includes, at four corner regions along a peripheral edge, four respective pockets, each pocket being configured to receive an end of a corresponding beam.

26. The device for stabilizing a beach umbrella on a ground according to claim 24, further comprising a second fabric sheet having a substantially rectangular shape, said second fabric sheet comprising four pockets arranged at respective corner regions of said second fabric sheet, each pocket being configured to receive an end of a corresponding beam, wherein said second fabric sheet is removably attachable to said beams and comprises a central opening for accommodating said base member, said second fabric sheet further comprising two cylindrical pockets projecting from a surface of said second fabric sheet.

27. The device for stabilizing a beach umbrella on a ground according to claim 24, wherein when said device is attached to a lower portion of said pole of said beach umbrella, and said first fabric sheet is tightened over said beams, said device forms a stabilization base for said beach umbrella configured to rest on said ground and to be covered, at least partially, by said ground.

28. The device for stabilizing a beach umbrella on a ground according to claim 26, wherein when said device is attached to an intermediate portion of said pole of said beach umbrella and said second fabric sheet is tightened over said beams, said device forms a support surface for accessories or beverages, said pockets being configured for receiving said accessories or beverages.

29. The device for stabilizing a beach umbrella on a ground according to claim 17, wherein when said device is attached to a lower portion of said pole of said beach umbrella, and said first fabric sheet is tightened over said beams, said device forms a stabilization base for said beach umbrella configured to rest on said ground and to be covered, at least partially, by said ground

30. The device for stabilizing a beach umbrella on a ground according to claim 20, wherein, when said device is attached to an intermediate portion of said pole of said beach umbrella and said second fabric sheet is tightened over said beams, said device forms a support surface for accessories or beverages, said pockets being configured for receiving said accessories or beverages.
